(19) United States
(12) Patent Application Publication
(10) Pub. No.: US 2023/0405769 A1
(43) Pub. Date: Dec. 21, 2023

(54) HAND TOOL

(71) Applicant: STANLEY BLACK & DECKER MEA FZE, Jebel Ali (AE)

(72) Inventor: Anthony Poillot, Besançon (FR)

(21) Appl. No.: 18/334,766

(22) Filed: Jun. 14, 2023

(30) Foreign Application Priority Data
Jun. 15, 2022 (EP) 22179149.4

(51) Int. Cl. B25B 7/10; B25B 7/12

(52) U.S. Cl. CPC B25B 7/10; B25B 7/123

(57) ABSTRACT

The present invention relates to a hand tool. More specifically, a rapid adjust multigrip tool having a first arm, second arm, linking mechanism and locking mechanism. The first arm is connected to the second arm via a primary pivot. The linking mechanism biases the arms away from one another. The locking mechanism allows an operator to selectively secure the first and second arms together.

### CROSS-REFERENCE TO RELATED APPLICATIONS

This application claims priority to EP Patent Application No. 22179149.4, filed on Jun. 15, 2022, which is incorporated herein by reference in its entirety.

### FIELD OF THE INVENTION

The present invention relates to a multigrip tool. More specifically, a rapid adjustable multigrip tool.

### BACKGROUND OF THE INVENTION

The general concept of a multigrip hand tool is well known. These tools allow users to manipulate objects, such as nuts. In operation, a user will open the jaws of the hand tool by separating the handles from one another. The operator can grasp the nut between the jaws and apply torque thereto. The space between the jaws of a multigrip tool can be adjusted thereby allowing the operator to grasp and apply torque to nuts of various sizes. It is not uncommon for such multigrip tools to have spring biased linking mechanisms. Said linking mechanisms assist the operator to grasp larger nuts by biasing the handles away from one other thereby increasing the space between the jaws.

While it is advantageous to have the jaws biased towards their open position during operation, said bias can be seen to be a drawback when said hand tool is not in use and needs to be stored. During storage, said tools are often placed within a confined container. In said container, it is preferable for the hand tool to take up as little space as possible. This permits other tools to be neatly and safely stored in the container along with the hand tool. It would be advantageous to have a multigrip hand tool that includes both a spring biased linking mechanism and a selective lock that permits safe and compact storage.

### SUMMARY OF THE INVENTION

According to an aspect of the invention, a hand tool having a first arm with a first handle portion and a first jaw portion. The hand tool also includes a second arm with a second handle portion and a second jaw portion. The first and second arms are connected to one another about a primary pivot and movable between a closed position and an open position. In the closed position, the first and second handle portions are in proximity to one another, and the first and second jaw portions are in proximity to one another. In the open position, the first and second handle portions are distal from one another, and the first and second jaw portions are also distal from one another. The hand tool further includes a linking mechanism that includes a lock protrusion. The linking mechanism is positioned between the first and second arms. The hand tool is characterized in that it further includes a locking mechanism that is configured to secure the first and second arms in their closed position. The locking mechanism includes a lip positioned on one of the first or second handle portions and is movable between a locked position and an unlocked position. In the locked position, the lip engages the lock protrusion and secures the first and second arms in their closed position. In the unlocked position, the lip is disengaged from the lock protrusion and the first and second arms are free to move from their closed position to their open position.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the root terms “include” and/or “have”, when used in this specification, specify the presence of stated features, steps, operations, elements, and/or components, but do not preclude the presence or addition of at least one other feature, step, operation, element, component, and/or groups thereof.

As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus.

For definitional purposes and as used herein, “connected” or “attached” includes physical or electrical, whether direct or indirect, affixed or adjustably mounted. Thus, unless specified, “connected” or “attached” is intended to embrace any operationally functional connection. When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

As used herein, “substantially,” “generally,” “slightly” and other words of degree are relative modifiers intended to indicate permissible variation from the characteristic so modified. It is not intended to be limited to the absolute value or characteristic which it modifies but rather possessing more of the physical or functional characteristic than its opposite, and approaching or approximating such a physical or functional characteristic.

In the following description, reference is made to the accompanying attachments and drawings which are provided for descriptive and illustration purposes as representative of specific exemplary embodiments in which the invention may be practiced. Given the following description of the specification and drawings, the apparatus, methods, and systems should become evident to a person of ordinary skill in the art. Further areas of applicability of the present teachings will become apparent from the description and illustrations provided herein. It is to be understood that other embodiments can be utilized and that structural changes based on presently known structural and/or functional equivalents can be made without departing from the scope of the invention.

### BRIEF DESCRIPTION OF THE DRAWINGS

The above-mentioned and other features, embodiments, and advantages of this invention, and the manner of attaining them, will become more apparent and the invention will be better understood by reference to the following descriptions of embodiments of the invention taken in conjunction with the accompanying drawings, wherein:

FIG. 1 illustrates plan view of the tool in its closed and locked position;

FIG. 2 illustrates a plan view of the tool in its closed and unlocked position;

FIG. 3 illustrates a plan view of the tool in its open position;

FIG. 4 illustrates an exploded view of the tool;

FIG. 5 illustrates a plan cutaway view of the tool in its closed and locked position;

FIG. 6 illustrates a plan cutaway view of the tool in its open position;

FIG. 7A illustrates a perspective view of the tool in its closed and locked position;

FIG. 7B is an inset of FIG. 7A illustrating detailed perspective view of the locking mechanism in its locked position;

FIG. 8A illustrates a perspective view of the tool in its closed and unlocked position;

FIG. 8B is an inset of FIG. 8A illustrating detailed perspective view of the locking mechanism in its unlocked position;

FIG. 9A is a detailed perspective view of the locking mechanism with a transparent slider in its locked position;

FIG. 9B is a detailed perspective view of the locking mechanism with a transparent slider in its unlocked position; and

FIG. 10 is a plan view of an alternate embodiment of the tool in its closed and locked position.

Corresponding illustrated images and attachments indicate corresponding parts throughout the several views of the present invention. The exemplifications set out herein illustrate embodiments of the present invention, and such exemplifications are not to be construed as limiting the scope of the present invention in any manner.

These and other features of the invention will become apparent upon review of the following description of the presently preferred embodiments of the invention, taken into conjunction with the figures.

### DETAILED DESCRIPTION OF THE ILLUSTRATED EMBODIMENT(S)

A detailed description of apparatuses, methods, and systems, consistent with embodiments of the present disclosure is provided below. While several embodiments are described, it should be understood that the disclosure is not limited to any one embodiment, but instead encompasses numerous alternatives, modifications, and equivalents. In addition, while numerous specific details are set forth in the following description in order to provide a thorough understanding of the embodiments disclosed herein, some embodiments can be practiced without some or all of these details. Moreover, for the purpose of clarity, certain technical material that is known in the related art has not been described in detail in order to avoid unnecessarily obscuring the disclosure.

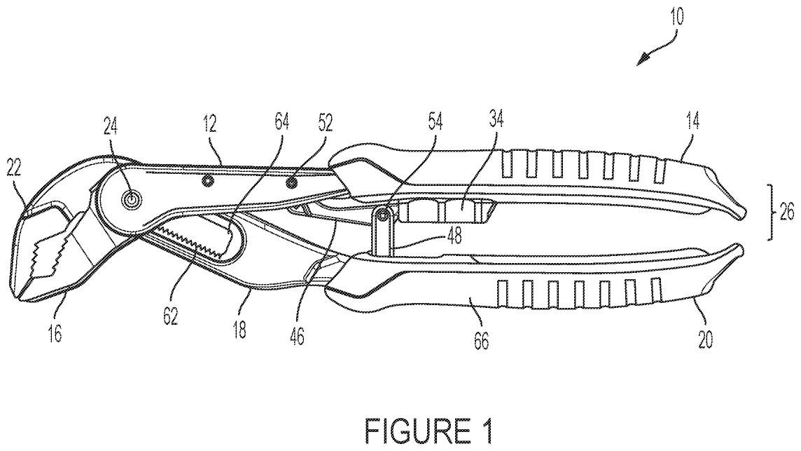

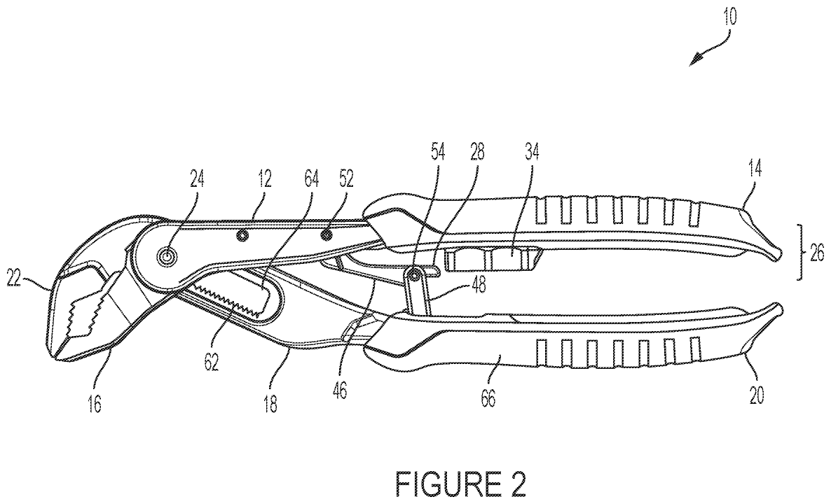

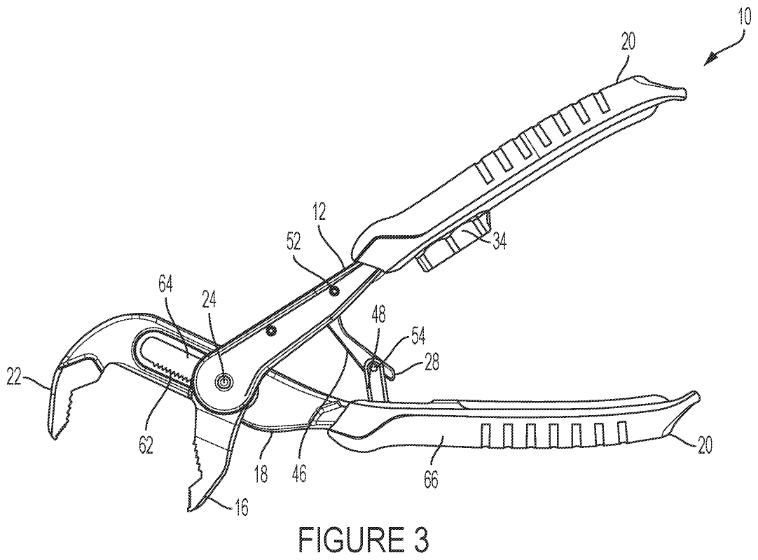

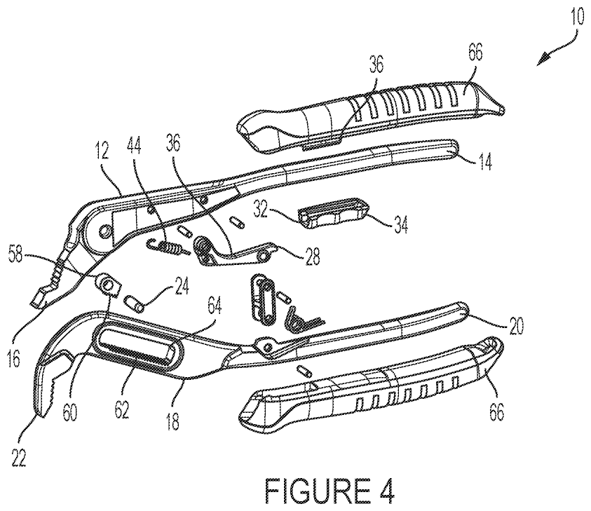

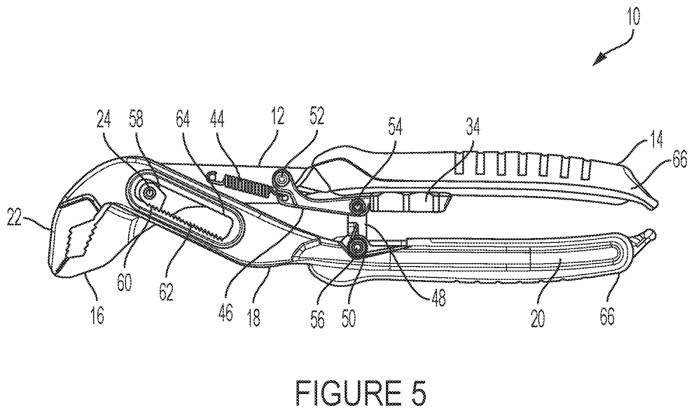

FIGS. 1, 2 and 3 depict plan views of a hand tool 10 according to the present invention. The hand tool 10 includes a first arm 12 having a handle portion 14 and a first jaw portion 16. The hand tool 10 also includes a second arm 18 that has a second handle portion 20 and a second jaw portion 22. The first and second arms 12, 18 are connected to one another about a primary pivot 24, and are movable between a closed position (FIGS. 1 and 2) and an open position (FIG. 3). In the closed position, the first and second handle portions 14, 20 are in proximity with one another, and the first and second jaw portions 16, 22 are also in proximity to one another. In the open position, the first and second handle portions 14, 20 are distal from one another, and so are the first and second jaw portions 16, 22.

The hand tool 10 also includes a linking mechanism 26 that includes a lock protrusion 28. The linking mechanism 26 is positioned between the first and second arms 12, 18.

The hand tool 10 also includes a locking mechanism 30 that is configured to secure the first and second arms 12, 18 in their closed position. The locking mechanism includes a lip 32 positioned on one or the other of the first and second handle portions 14, 20. The lip 32 is movable between a locked position and an unlocked position. In the locked position, the lip 32 engaged the lock protrusion 28 and secures the first and second arms 12, 18 in their closed position. In the unlocked position, the lip 32 is disengaged from the lock protrusion 28, and the first and second arms 12, 18 are free to move from their closed position to their open position.

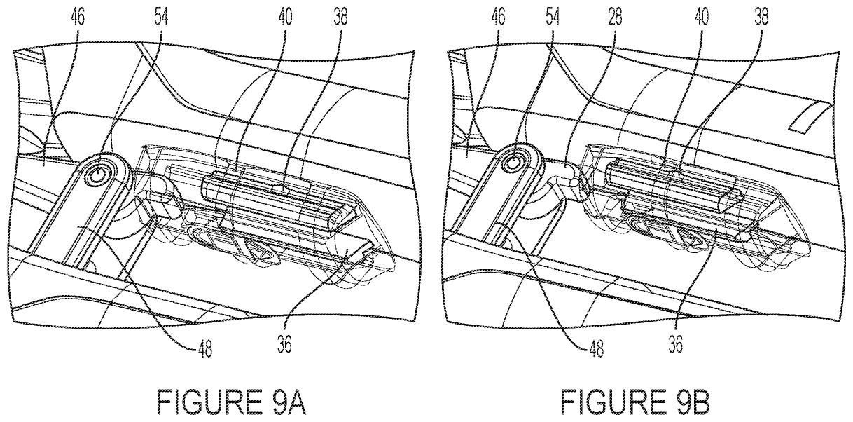

In a preferred embodiment, the lip 32 of the locking mechanism is integrated into a sliding cover 34. The sliding cover 34 is configured to slide between a first position, wherein the lip 32 is in its locked position, and a second position, wherein the lip 32 is in its unlocked position. In yet another preferred embodiment, the locking mechanism 30 further includes at least one rail 36 that is positioned between the sliding cover 34 and one of the first or second handle portions 14, 20. The at least one rail 36 is configured to facilitate the sliding movement of the sliding cover 34. In still a further preferred embodiment, as best seen in FIGS. 9a and 9b, the rail(s) 36 of the hand tool 10 include at least one protrusion 38 that are configured to engage a corresponding depression 40 on the interior of the sliding cover 34. In yet a more preferred embodiment, there may be multiple depressions 40 that are positioned such that when protrusion 38 engages a depression 40, the sliding cover 34 is secured in either its first or second position.

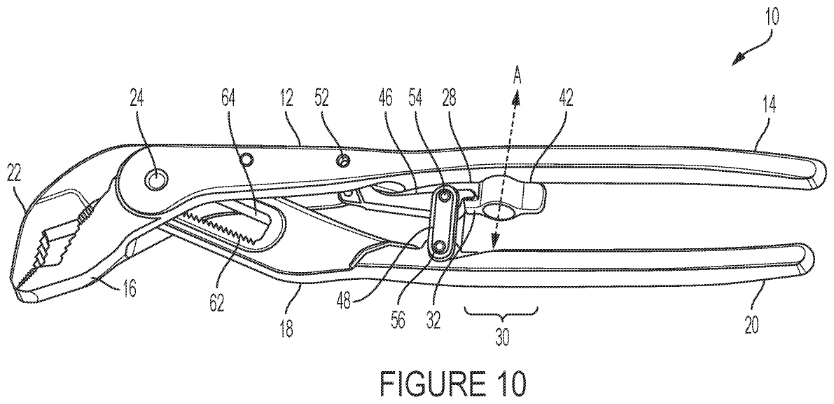

In an alternate embodiment as shown in FIG. 10, the lip 32 is integrated into a swivel 42. The swivel 42 is configured to rotate about an axis (A) between a first position and a second position. In the first position, the lip 32 is in its locked position, wherein it engages the lock protrusion 28. In the unlocked position, the lip 32 is disengaged from the lock protrusion 28.

Those skilled in the art will recognize that although the locking mechanism 30 depicted in the figures herein show the lip 32, sliding cover 34, rail(s) 36 and swivel 42 as being attached to the first handle portion 14, they could just also be attached to the second handle portion 20 without departing from the scope of. the invention.

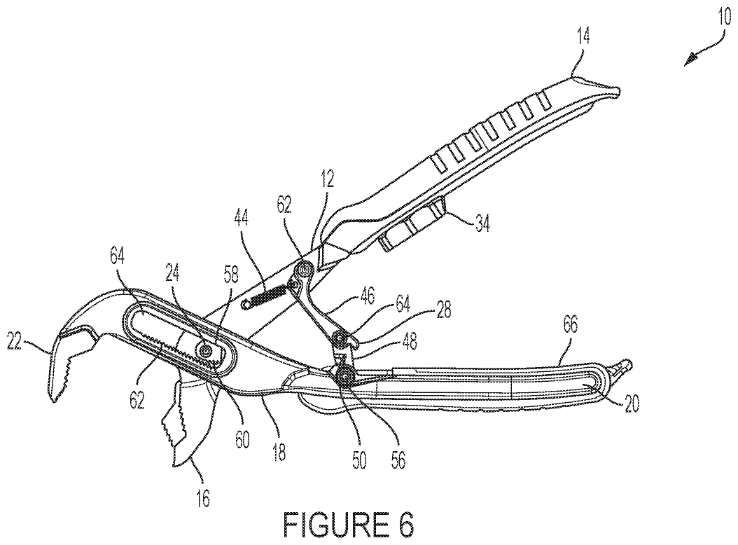

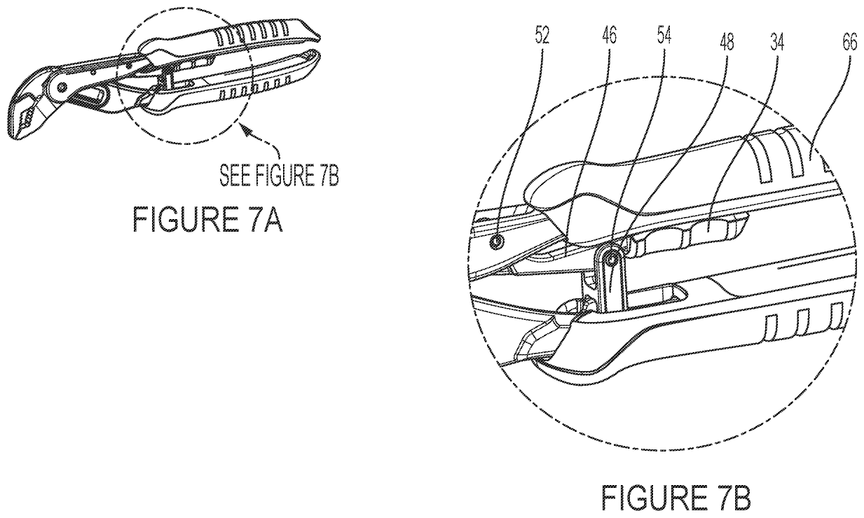

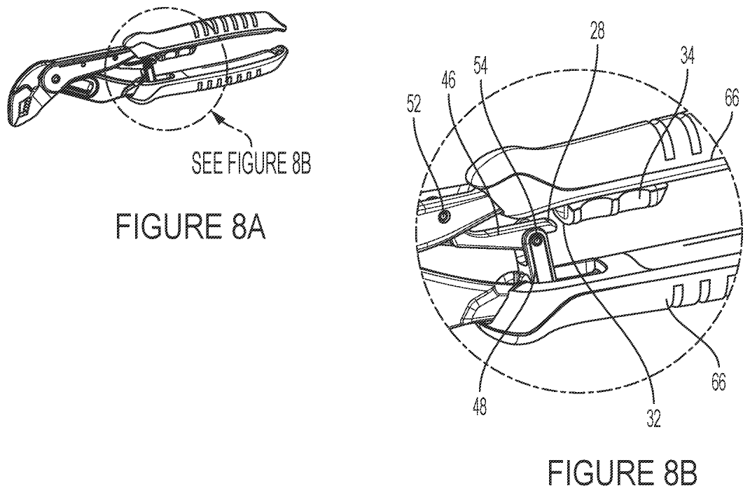

In yet another preferred embodiment, the linking mechanism 26 of the hand tool 10 is configured to bias the first and second arms 12, 18 toward their open position. As best seen in FIG. 6, this biasing is achieved though several elements that are a part of the linking mechanism. Said elements include a first spring 44, a first link 46, a second link 48, and a second spring 50. The first spring 44, which may be a compression spring, is engaged to the first arm 12 and the first link 46. The first link 46 is pivotally attached to the first arm 12 about a first linking pivot 52. The first link 46 is also pivotally attached to the second link 48 about a second linking pivot 54. The second link 54 is also pivotally attached to the second arm 18 about a third linking pivot 56. The second spring 50, which may be a torsion spring, is engaged to both the second link 48 and the second arm 18.

In yet another preferred embodiment, the primary pivot 24 of the hand tool 10 may be an adjustable pawl 58. The adjustable pawl 58 may have a plurality of serrated teeth 60 that are configured to engage mating serrated teeth 62 that are disposed in an opening 64 defined in the second arm 18.

Those skilled in the art will recognize that the hand tool 10 may also include standard hand tool features such as grips 66 which work to prevent the tool from slipping in the operator's hand during use.

The example and alternative embodiments described above may be combined in a variety of ways with each other. It should be noted that the present invention may, however, be embodied in many different forms and should not be construed as limited to the embodiments set forth herein; rather, the embodiments set forth herein are provided so that the disclosure will be thorough and complete, and will fully convey the scope of the invention to those skilled in the art. Furthermore, the steps and number of the various steps illustrated in the figures may be adjusted from that shown. The accompanying figures and attachments illustrate exemplary embodiments of the invention.

Although the present invention has been described in terms of particular example and alternative embodiments, it is not limited to those embodiments. Alternative embodiments, examples, and modifications which would still be encompassed by the invention may be made by those skilled in the art, particularly in light of the foregoing teachings.

Those skilled in the art will appreciate that various adaptations and modifications of the example and alternative embodiments described above can be configured without departing from the scope and spirit of the invention. Therefore, it is to be understood that, within the scope of the appended claims, the invention may be practiced other than as specifically described herein.

What is claimed is:

1. A hand tool comprising:
a first arm having a first handle portion and a first jaw portion,
a second arm having a second handle portion and a second jaw portion, wherein the first and second arms are connected to one another about a primary pivot and movable between a closed position and an open position, and wherein in said closed position, the first and second handle portions are in proximity to one another, and the first and second jaw portions are in proximity to one another, and wherein in said open position, the first and second handle portions are distal from one another, and the first and second jaw portions are distal from one another,
a linking mechanism having a lock protrusion, and wherein said linking mechanism is positioned between the first and second arms, and
characterized in that the hand tool further comprises a locking mechanism configured to secure the first and second arms in their closed position, and wherein said locking mechanism includes a lip positioned on one of the first or second handle portion and movable between a locked position and an unlocked position, wherein in said locked position, the lip engages the lock protrusion and secures the first and second arms in their closed position, and wherein in said unlocked position, the lip is disengaged from the lock protrusion and the first and second arms are free to move from their closed position to their open position.

2. The hand tool of claim 1, wherein the lip is integrated into a sliding cover configured to slide between a first position wherein the lip is in its locked position, and a second position, wherein the lip is in its unlocked position.

3. The hand tool of claim 1, wherein the locking mechanism further includes at least one rail positioned between the sliding cover and the one of the first or second handle portion, and wherein said at least one rail is configured to facilitate sliding movement of the sliding cover.

4. The hand tool of claim 2, wherein the locking mechanism further includes at least one rail positioned between the sliding cover and the one of the first or second handle portion, and wherein said at least one rail is configured to facilitate sliding movement of the sliding cover.

5. The hand tool of claim 3, wherein the at least one rail includes at least one protrusion configured to engage a corresponding depression on the sliding cover to secure the sliding cover in either its first or second position.

6. The hand tool of claim 1, wherein the lip is integrated into a swivel that is configured to rotate about an axis (A) between a first position, wherein said lip is in its locked position, and a second position wherein the lip is in its unlocked position.

7. The hand tool of claim 1, wherein the linking mechanism is configured to bias the first and second arms toward their open position, and further includes a first spring, a first link, a second link and a second spring, and wherein the first spring is engaged to both the first arm and the first link, and wherein the first link is pivotally attached to the first arm about a first linking pivot and pivotally attached to the second link about a second linking pivot, and wherein the second link is further pivotally attached to the second arm about a third linking pivot, and wherein the second spring is engaged to both the second link and the second arm, and wherein the first link further includes the lock protrusion.

8. The hand tool of claim 3, wherein the linking mechanism is configured to bias the first and second arms toward their open position, and further includes a first spring, a first link, a second link and a second spring, and wherein the first spring is engaged to both the first arm and the first link, and wherein the first link is pivotally attached to the first arm about a first linking pivot and pivotally attached to the second link about a second linking pivot, and wherein the second link is further pivotally attached to the second arm about a third linking pivot, and wherein the second spring is engaged to both the second link and the second arm, and wherein the first link further includes the lock protrusion.

9. The hand tool of claim 7, wherein the first spring is a compression spring, and wherein the second spring is a torsion spring.

10. The hand tool of claim 1, wherein the primary pivot is an adjustable pawl having a plurality of serrated teeth that are configured to selectively engage mating serrated teeth disposed in an elongated opening defined in the second arm.

11. The hand tool of claim 3, wherein the primary pivot is an adjustable pawl having a plurality of serrated teeth that are configured to selectively engage mating serrated teeth disposed in an elongated opening defined in the second arm.

12. The hand tool of claim 1, wherein the first and second handle portions include grips.
